(19) United States
(12) Patent Application Publication
(10) Pub. No.: US 2017/0208866 A1
(43) Pub. Date: Jul. 27, 2017

(54) ELECTRONIC CIGARETTE

(71) Applicant: HUIZHOU KIMREE TECHNOLOGY CO., LTD., Huizhou, Guangdong (CN)

(72) Inventor: Qiuming Liu, Shenzhen, Guangdong (CN)

(21) Appl. No.: 15/329,257

(22) PCT Filed: Jul. 31, 2014
(86) PCT No.: PCT/CN2014/083466

§ 371 Date: Jan. 26, 2017

(51) Int. Cl. A24F 47/00; H05B 1/02; A24F 7/02

(52) U.S. Cl. CPC A24F 47/008; A24F 7/02; H05B 1/0244; H05B 2203/021

(57) ABSTRACT

Provided is an electronic cigarette comprising a smoking end, an atomization assembly and a battery assembly; an airflow passage communicating with the smoking end is defined in the electronic cigarette; one end of the battery assembly is provided with a first connection sleeve connected to the atomization assembly; a peripheral wall of the first connection sleeve is provided with at least one first air inlet hole; a side wall of a first accommodation chamber is provided with at least one second air inlet hole communicating with first accommodation chamber and the first air inlet hole; thus it is unnecessary for the airflow to pass through the electrode before entering the smoking end, such that a circulation of the air flow is smoother, noise is reduced, and the battery assembly and atomization assembly are prevented from being mixed up during use.

### FIELD OF THE INVENTION

The present application relates to a field of electric heating products, and more particularly relates to an electronic cigarette.

### BACKGROUND OF THE INVENTION

In the prior art, air inlet channels of an electronic cigarette bend a lot, then times of that airflow impacts a barrel wall increased, resulting in a larger noise.

As shown in FIG. 1, the electronic cigarette in the prior art comprises an atomizer 100 and a battery rod 200 connected to the atomizer 100, an atomization base 104 for fixing a heating wire assembly and an airflow passage for airflow to flow are defined in the atomizer 100, and the airflow passage is defined axially through the atomization base 104, a abutting surface of a connection of the battery rod 200 and the atomizer 100 is provided with an air inlet 201 which is communicated with the airflow passage.

A first upper electrode 102 electrically connected to the battery rod 200 is defined in one end of the atomizer 100 which is close to the battery rod 200; correspondingly, a lower electrode 202 which is abutted against and electrically connected to the first upper electrode 102 is defined in one end of the battery rod 200 which is close to the atomizer 100. A first channel 103 for airflow to flow is defined axially through the atomizer 100, and a second channel 104 communicated with the first channel 103 is defined on an abutting surface of the first upper electrode 102 and the first lower electrode 202. Airflow flowing from the air inlet 201 goes into the atomizer 100 successively through the second channel 104 and the first channel 103. Since airflow passages of the electronic cigarette bend a lot, then the times of that airflow impacts the barrel wall increased, resulting in a larger noise, and effecting users' experience effects.

In general, a battery in the battery rod 200 is rechargeable or replaceable, namely, the battery rod 200 of the electronic cigarette can be reused, and after smoke liquid in the atomizer 100 is used up, it is necessary to refill the smoke liquid or directly replace a new atomizer 100, if the new atomizer 100 is used to replace, the new atomizer 100 is necessary to match with the re-used battery rod 200.

Designs of the atomizer 100 and the battery rod 200 are different for different electronic cigarettes, such as a size, a supply voltage of the battery, and so on, during an usage, if a consumer uses a non-matching atomizer 100 together with the battery rod 200, it may cause problems such as a malfunction of the electronic cigarette or an abnormal taste in use. The battery rod 200 and the atomizer 100 of the prior arts cannot be known whether they are matched with each other before the malfunction or the abnormal taste occurs, thereby causing troubles to the users.

### SUMMARY OF THE INVENTION

Technical problems to be solved in the present invention is to provide an electronic cigarette, aiming at defects in the prior art.

Technical solutions of the present application for solving the technical problems are as follows:

An electronic cigarette is provided, the electronic cigarette comprises an electronic cigarette body, the electronic cigarette body is provided with a smoking end, an atomization assembly for atomizing smoke oil, and a battery assembly electrically connected to the atomization assembly for supplying electrical power to the atomization assembly; an airflow passage communicating with the smoking end for airflow to flow is defined in the electronic cigarette body; one end of the battery assembly is provided with a first connection sleeve connected to the atomization assembly, at least one first air inlet hole is defined on a peripheral wall of the first connection sleeve; the atomization assembly comprises an atomization base for fixing components within the atomization assembly, and a second connection sleeve which is insertably connected to the first connection sleeve;

The airflow passage comprises a vent hole and a first accommodation chamber, the vent hole axially goes through the atomization base, the first accommodation chamber is communicated with the vent hole and is defined at an end of the second connection sleeve which is opposite to the battery assembly; a side wall of the first accommodation chamber is provided with at least one second air inlet hole communicating the first accommodation chamber and the first air inlet hole, an end of the second air inlet hole opposite to the first accommodation chamber extends toward a direction close to the battery assembly and ensures that an angle formed by an extending direction of the second air inlet hole and an axis of the second connection sleeve is less than 90, so that an outside airflow is directly introduced into the first accommodation chamber and then flows to the smoking end through the vent hole.

The electronic cigarette in the present invention, an axis of the first air inlet hole is perpendicular to an axis of the first connection sleeve or coincides with an axis of the second air inlet hole.

The electronic cigarette in the present invention, the first connection sleeve is in engagement with the second connection sleeve, the first air inlet hole is provided on the peripheral wall of the first connection sleeve which is close to the atomization assembly.

The electronic cigarette in the present invention, quantity of the first air inlet hole is plural, a plurality of first air inlet holes are uniformly distributed on the peripheral wall of the first connection sleeve surrounding an axis of the first connection sleeve.

The electronic cigarette in the present invention, the second connection sleeve is convexly provided with an annular outer flange, the second air inlet hole is provided on a side of the annular outer flange close to the battery assembly.

The electronic cigarette in the present invention, the battery assembly further comprises a battery sleeve, and a battery which is fixed in the battery sleeve and is configured for supplying the electrical power to the atomization assembly, the first connection sleeve is fixed at an end of the battery sleeve which is close to the atomization assembly, and is electrically connected to the battery and the second connection sleeve, respectively.

The electronic cigarette in the present invention, an inner peripheral surface of the first connection sleeve is provided with internal screw threads, a first annular flange is convexly formed on an inner wall of the first connection sleeve, a first insulating member and a third connection member are embedded successively in the first annular flange, the third connection member is electrically connected to the battery.

The electronic cigarette in the present invention, the atomization assembly further comprises an atomization sleeve, the atomization base is fixed in the atomization sleeve, the second connection sleeve is connected to an end of the atomization sleeve which is close to the battery assembly and is electrically connected to the first connection sleeve; a peripheral surface of the second connection sleeve is provided with external screw threads which are matched with the inner screw threads.

The electronic cigarette in the present invention, an inner wall of the second connection sleeve is convexly provided with a second annular flange, a second insulating member and a fourth connection member are embedded successively in the second annular flange, the fourth connection member is electrically connected to the third connection member.

The electronic cigarette in the present invention, the atomization assembly further comprises a heating wire assembly for atomizing the smoke oil, and a vent tube for fixing the heating wire assembly, the vent tube is fixed on the atomization base.

The electronic cigarette in the present invention, the battery assembly further comprises an airflow sensor configured for detecting an airflow signal, and a control unit for receiving a signal generated by the airflow sensor and controlling an operating state of the heating wire assembly in response to the signal, the control unit is respectively connected to the battery and the airflow sensor.

The electronic cigarette in the present invention, the smoking end is detachably connected to the atomization assembly.

Applications of the electronic cigarette of the present invention has following advantages: firstly, a second air inlet hole is formed in the side wall of the first accommodation chamber, namely, the airflow enters the first accommodation chamber of the second connection sleeve through the air inlet holes and then flows into the atomization assembly directly through the vent hole in the atomization base, so that the airflow can enter the smoking end without passing through electrodes within the electronic cigarette, then enabling a reduction of the airflow passage bending, reducing a flow distance of the airflow, while reducing a number of air impinging on the electrodes, enabling the airflow to flow better and smooth, reducing a generation of the noise, so that users smoke more easily. Secondly, the second inlet hole is an inclined structure, since one end of the second air inlet hole is formed on the inner wall of the first accommodation chamber, and the other end of the second air inlet hole extends toward a side close to the battery assembly, so that the airflow can flow toward the side of the atomization base and flow through the vent hole on the atomization base to enter into the smoking end and smoked by the users, it can prevent the airflow from directly impinging on the electrodes to effectively reduce the noise. Finally, since the first air inlet hole and the second air inlet hole are respectively provided in the first connection sleeve and the second connection sleeve, only when the first air inlet hole on the first connection sleeve is communicated with the second air inlet hole on the second connection sleeve, can the airflow flows from the outside into the electronic cigarette, so that the battery assembly can be used to match with and identify the atomization assembly to effectively prevent the electronic cigarette battery assembly from a combining use with a non-matching atomization assembly to avoid the malfunction, the abnormal taste and other issues when consumers use a combining used and non-matching electronic cigarette, thus smoke quality is more secure and reliable.

### BRIEF DESCRIPTION OF THE DRAWINGS

The present invention will be further described with reference to the accompanying drawings and embodiments in the following.

FIG. 1 is a structural schematic diagram of an electronic cigarette in the prior arts;

FIG. 2 is a structural schematic diagram of the electronic cigarette in a first preferred embodiment of the present invention;

FIG. 3 is a partial enlarged view of A position of the electronic cigarette in FIG. 2;

FIG. 4 is a structural schematic diagram of the atomization assembly of the electronic cigarette in FIG. 2;

FIG. 5 is a structural schematic diagram of a first connection sleeve of the atomization assembly;

FIG. 6 is an explosion diagram of the electronic cigarette in FIG. 2;

FIG. 7 is a structural schematic diagram of the electronic cigarette in a second preferred embodiment of the present invention;

FIG. 8 is a partial enlarged view of B position of the electronic cigarette in FIG. 7.

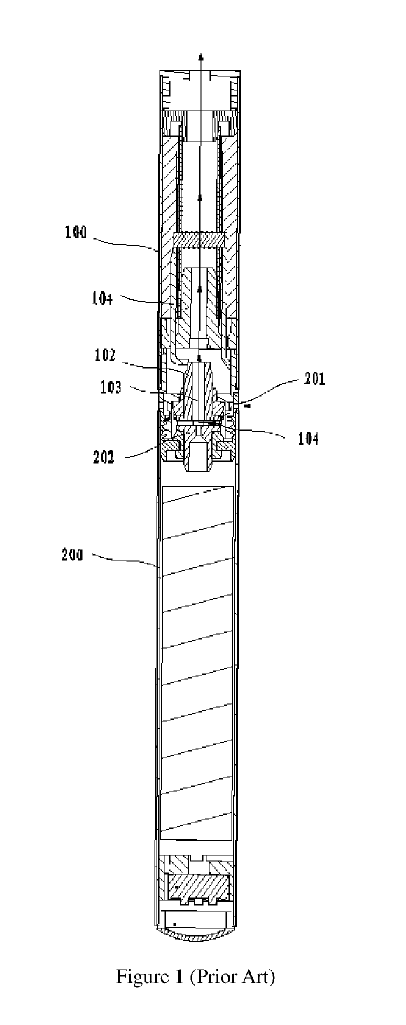

### DETAILED DESCRIPTION OF THE PREFERRED EMBODIMENT

To make the technical feature, objective and effect of the present application be understood more clearly, now the specific implementation of the present application is described in detail with reference to the accompanying drawings and embodiments.

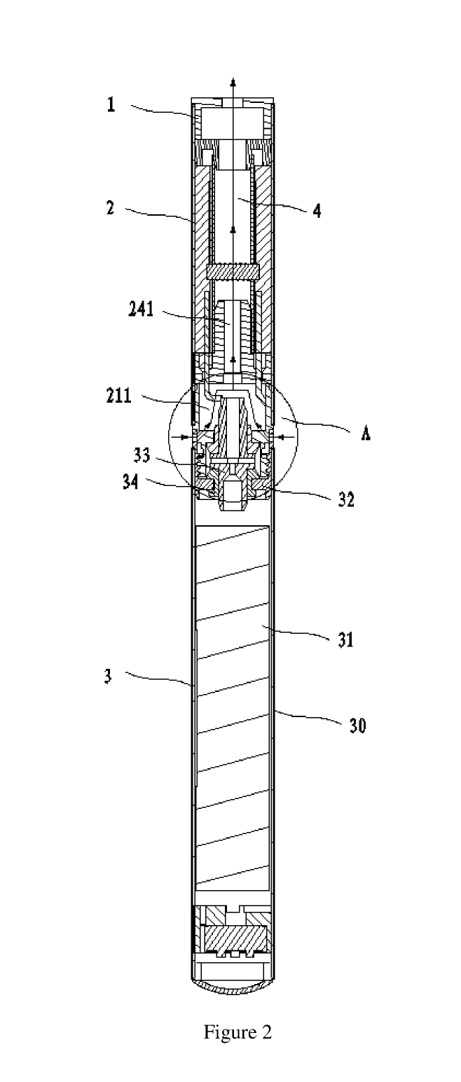

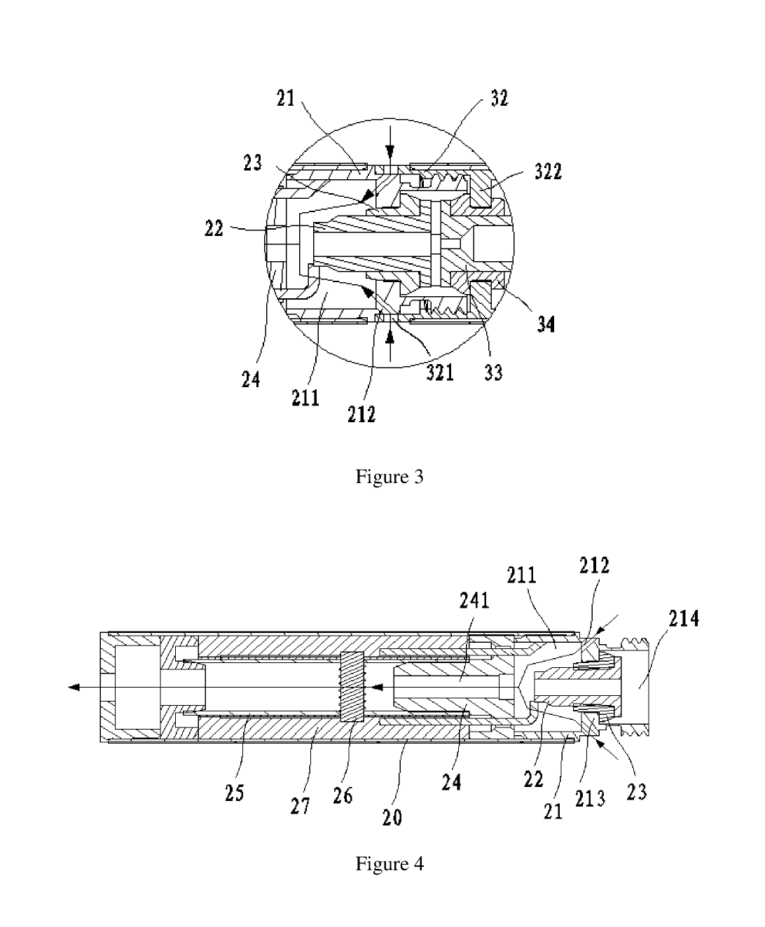

As shown in FIG. 2 and FIG. 3, an electronic cigarette of a first preferred embodiment of the present invention, the electronic cigarette comprising an electronic cigarette body, the electronic cigarette body is provided with a smoking end 1, an atomization assembly 2 for atomizing smoke oil, and a battery assembly 3 connected to the atomization assembly 2 for supplying electrical power to the atomization assembly 2; an airflow passage 4 communicating with the smoking end 1 for airflow to flow is defined in the electronic cigarette body; one end of the battery assembly 3 is provided with a first connection sleeve 32 connected to the atomization assembly 2, at least one first air inlet hole 321 is defined on a peripheral wall of the first connection sleeve 32; the atomization assembly 2 comprises an atomization base 24 and a second connection sleeve 21 which is insertably connected to the first connection sleeve 32;

Further, the airflow passage 4 comprises a vent hole 241 and a first accommodation chamber 211, the vent hole 241 axially goes through the atomization base 24, the first accommodation chamber 211 is communicated with the vent hole 241 and is defined at an end of the second connection sleeve 21 which is opposite to the battery assembly 3; a side wall of the first accommodation chamber 211 is provided with at least one second air inlet hole 212 communicating the first accommodation chamber 211 and the first air inlet hole 321, an end of the second air inlet hole 212 opposite to the first accommodation chamber 211 extends toward a direction close to battery assembly 3 and ensures that an angle formed by an extending direction of the second air inlet hole 212 and an axis of the second connection sleeve 21 is less than 90, so that an outside airflow is directly introduced into the first accommodation chamber 211 and then flows to the smoking end 1 through the vent hole 241.

In the present invention, the second inlet hole 212 is an inclined structure, since one end of the second air inlet hole 212 is formed on an inner wall of the first accommodation chamber 211, and the other end of the second air inlet hole 212 extends toward a side close to the battery assembly 3 so that the airflow can flow toward the side of the atomization base 24, and flow through the vent hole 241 on the atomization base 24 to enter into the smoking end 1 and smoked by users, it can prevent the airflow from directly impinging on electrodes to effectively reduce the noise.

Further, since the second air inlet hole 212 is formed in the side wall of the first accommodation chamber 211, namely, the airflow enters the first accommodation chamber 211 of the second connection sleeve 21 through the air inlet hole and flows into the atomization assembly 2 directly through the vent hole 241 on the atomization base 24, so that the airflow can enter the smoking end 1 without passing through electrodes within the electronic cigarette, then enabling a reduction of the airflow passage bending, reducing a flow distance of the airflow, while reducing a number of airflow impinging on the electrodes, enabling the airflow to flow better and smooth, reducing a generation of the noise, so that the users smoke more easily.

Besides, since air inlet holes are respectively provided in the first connection sleeve 32 and the second connection sleeve 21, only when the first air inlet hole 321 on the first connection sleeve 32 is communicated with the second air inlet hole 212 on the second connection sleeve 21, can the airflow flow from the outside into the electronic cigarette, then when the second connection sleeve 21 of the atomization assembly 2 on which the second air inlet hole 212 is not provided is connected to the battery assembly 3, the air flow is not smooth at the time of smoking and feels more suffocated or since no air flows into the atomization assembly 2, it is difficult for smoke in the atomization assembly 2 to enter an user's mouth, so that the battery assembly 3 can be used to match with and identify the atomization assembly 2 to effectively prevent the electronic cigarette battery assembly 3 from a combining use with a non-matching atomization assembly 2 to avoid the malfunction, the abnormal taste and other issues when consumers use a combining used and non-matching electronic cigarette, thus quality of the electronic cigarette is more secure and reliable.

A specific configuration of the atomization assembly 2 will now be described in detail with reference to the embodiments shown in FIGS. 2, 3, 4, 5 and 6.

As illustrated by FIG. 4, the atomization assembly 2 comprises an atomization sleeve 20, a second connection sleeve 21, a fourth connection member 22, a second insulating member 23, an atomization base 24, a vent tube 25, a heating wire assembly 26 and an oil storage member 27.

The atomization sleeve 20 is generally a cylindrical structure, the second connection sleeve 21 is detachably connected to one end of the atomization sleeve 20, and the other end of the atomization sleeve 20 is fixedly connected to the smoking end 1, the smoking end 1 shown in FIG. 2 can be formed by extending and integrating with an end portion of the atomization sleeve 20, a suction nozzle (not shown) of the smoking end 1 may also be detachably connected to the atomization sleeve 20, in particular, the smoking end 1 and the atomizing sleeve 20 may be detachably connected using a threaded connection, a snap-fit connection or an interference fit connection, and so on. In the present embodiment, the suction nozzle is detachably connected to the atomization sleeve 20, a removable suction nozzle allows the user to change the suction nozzle or cleaning the suction nozzle at any time, not only can prevent the smoke oil from being sucked into the suction nozzle, but also can be better for the smoke oil in the atomization assembly 2 to be cleaned up.

The second connection sleeve 21 is connected to one end of the atomization sleeve 20 close to the battery assembly 3, and is detachably connected to the battery assembly 3. In the present embodiment, a peripheral surface of the second connection sleeve 21 is provided with external screw threads for electrically connecting to the battery assembly 3. It will be appreciated that in other embodiments the second connection sleeve 21 of the atomization assembly 2 may also be detachable attached to the battery assembly 3 by means of a snap-fit connection and other methods.

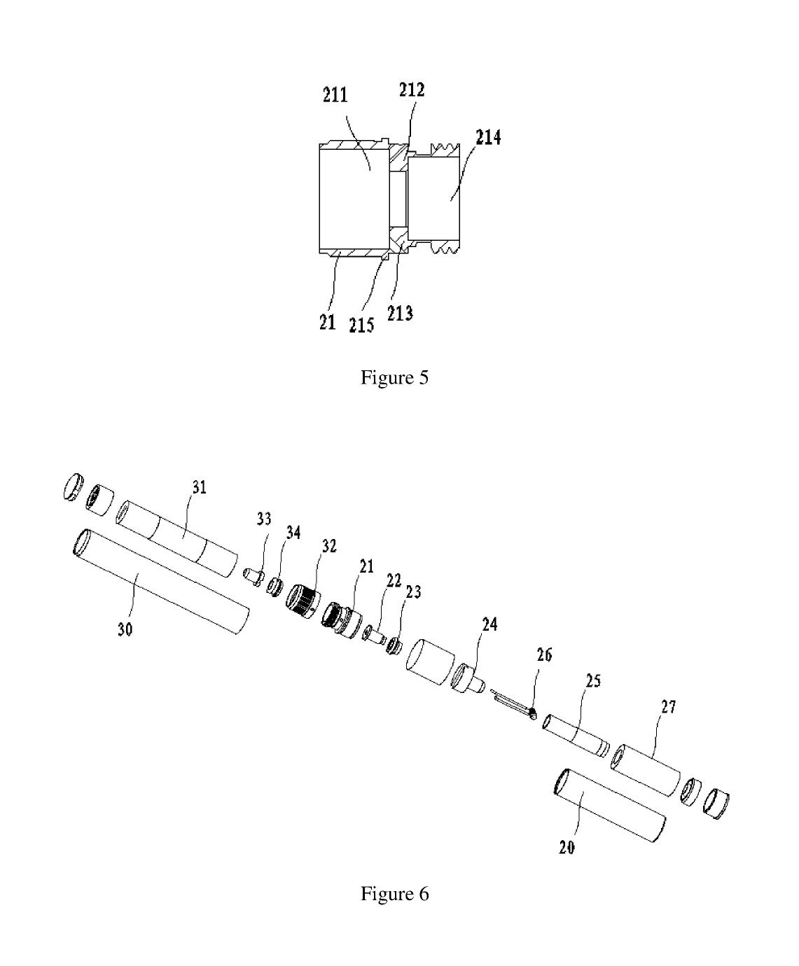

Specifically, as shown in FIG. 5, an inner wall of the second connection sleeve 21 is convexly provided with a second annular flange 213, the second annular flange 213 divides the inside of the second connection sleeve 21 into the first accommodation chamber 211 and the second accommodation chamber 214 which are spaced apart from each other. The first accommodation chamber 211 is located on a side of the second connection sleeve 21 which is opposite to the battery assembly 2, the second air inlet hole 212 is obliquely defined on a side wall of the first accommodation chamber 211 and allows the airflow to flow into the inside of the atomization assembly 2 through the first accommodation chamber 211

Further, quantity of the first air inlet hole 321 is plural, a plurality of first air inlet holes 321 are uniformly distributed on the peripheral wall of the first connection sleeve 32 surrounding an axis of the first connection sleeve 32, by increasing the quantity of the first air inlet holes 321, it is possible to effectively increase airflow volume, enable the airflow to flow more smoothly, reduce a generation of noise, and improve an user's experience.

Further, the first connection sleeve 32 is convexly provided with an annular outer flange 215, an end side edge of the atomization sleeve 20 abuts against the annular outer flange 215 to limit a displacement of the first connection sleeve 32 in the axial direction thereof. Besides, the second air inlet hole 212 is provided on a side of the annular outer flange 215 close to the battery assembly 3, so as to avoid that the second air inlet hole 212 is clogged by the atomization sleeve 20 when the first connection sleeve 32 is assembled, thereby influencing the flow of the airflow, resulting in that the electronic cigarette does not work normally.

Further, in order to prevent the airflow from impacting on the fourth connection member 22 which is extended into the first accommodation chamber 211 when the airflow flows, the fourth connection member 22, which is extended to the first accommodation chamber 211, is defined to be a cone table structure, and a generatrix of the cone table structure is parallel to an axis of the second air inlet hole 212. In this way, the airflow coming from the second air inlet hole flows directly into the vent hole 241 and would not cause the airflow to be bent to ensure the airflow is smooth and stable.

Further, the second annular flange 213 has a central hole (not shown in the figures) in which the fourth connection member 22 and the second insulating member 23 are sequentially arranged from outside to inside. The fourth connection member 22 is mainly configured for an electrical connection with a third connection member 33 of the battery assembly 3, the second insulating member 23 is located between the second connection sleeve 21 and the fourth connection member 22, so that the second connection sleeve 21 and the fourth connection member 22 are electrically isolated. Since the second connection sleeve 21 and the fourth connection member 22 are common electrical connection structures in the prior arts, the second insulating member 23 is an insulating structure which is conventionally known in the prior art, thus they are not explained in detail here.

The atomization base 24 is fixed in the atomization sleeve 20, the atomization base 24 mainly comprises a main body and a connecting tube (not shown in the figures) which are firmly connected to each other, and the vent hole 241 communicating with the first accommodation chamber 211 axially goes through the main body and the connecting tube, the airflow entering the first accommodation chamber 211 flows into the smoking end 1 through the vent hole 241. In other embodiments, the atomization base 24 may be formed integrally with the vent tube 25 or/and integrally formed with the first connection sleeve 32, and is not particularly limited thereto, as long as the atomization base 24 is capable of directly or indirectly fixing the components such as the heating wire assembly 26 or the vent pipe 25.

The vent tube 25 is mainly configured for fixing the heating wire assembly 26, and is sleeved on the connecting tube (not shown in the figures) of the atomization base 24. Specifically, the vent tube 25 is provided with a mounting hole (not shown) for accommodating the heater wire assembly 26, the heater wire assembly 26 is received in the mounting hole and is electrically connected to the battery assembly 3 through the second connection sleeve 21 and the fourth connection member 22, respectively. The oil storage member 27 is defined outside the vent pipe 25, and both ends of the heating wire assembly 26 are abutted against the oil storage member 27. In the present embodiment, the vent pipe 25 is a yellow wax pipe. Since the vent pipe 25, the heater wire assembly 26 and the oil storage member 27 are conventional in the prior arts, thus they are not described here. Besides, in other embodiments, the heating wire assembly 26 may be directly fixed to the atomization base 24, and is not particularly limited thereto.

A specific configuration of the battery assembly 3 will be described in detail below with reference to the embodiment shown in FIGS. 2 and 6.

As illustrated by FIG. 2, the battery assembly 3 comprises a battery sleeve 30, a battery 31, the first connection sleeve 32, the third connection member 33, a first insulating member 34, the air sensor and a control unit (not shown in the figures).

The battery sleeve 30 is generally a cylindrical structure, one end of the battery sleeve 30 which is close to the atomization assembly 2 is connected with the first connection sleeve 32 while the other end of the battery sleeve 30 is connected with a lamp cap (not shown in figures).

The battery 31 is fixed in the battery sleeve 30 and supplies the electrical power to the heating wire assembly 26 of the atomization assembly 2 for working.

The first connection sleeve 32 is connected to the one end of the battery sleeve 30 which is close to the atomization assembly 2, and is configured for being detachably connected to the atomization assembly 2. In the present embodiment, an inner peripheral surface of the first connection sleeve 32 is provided with internal screw threads for electrically connecting to the atomization assembly 2.

Specifically, at least one first air inlet hole 321 is defined on a peripheral wall of the first connection sleeve 32 which is close to the atomization assembly 2, and the first air inlet hole 321 is communicated with the second air inlet hole 212 to enable the airflow flows into the first accommodation chamber 211 sequentially through the first air inlet hole 321 and the second air inlet port 212. In the present embodiment, an axis of the first air inlet hole 321 is perpendicular to an axis of the battery 30.

Further, a first annular flange 322 is convexly formed on an inner wall of the first connection sleeve 32, combining with FIG. 3, a central hole (not shown in the drawing) of the first annular flange 322 is provided with a third connection member 33 and a first insulating member 34 sequentially from the inside to the outside, the third connection member 33 is mainly configured for being electrically connected to the fourth connection member 22 of the atomization assembly 2, the first insulating member 34 is located between the first connection sleeve 32 and the third connection member 33 to enable an electrical isolation between the first connection sleeve 32 and the third connection sleeve 33. Since the first connection sleeve 32 and the third connection member 33 are common electrical connection structures in the prior arts, the first insulating member 34 is an insulating structure which is conventionally known in the prior art, thus they are not explained in detail here.

The airflow sensor and the control unit are fixed in one end of the battery sleeve 30 which is close to the lamp cap, the airflow sensor is mainly configured for detecting an airflow signal and generating a pulse signal, the control unit is mainly configured for receiving a signal generated by the airflow sensor and controlling an operating state of the atomization assembly 2 in response to the signal, the control unit is respectively connected to the battery 31 and the airflow sensor. Since the airflow sensor and the control unit both are the prior arts, they are not described here. In other embodiments, it is not necessary to provide the airflow sensor and the control unit, and the battery assembly 3 is controlled by a key switch to supply electrical power to the atomization assembly 2, and is not particularly limited thereto.

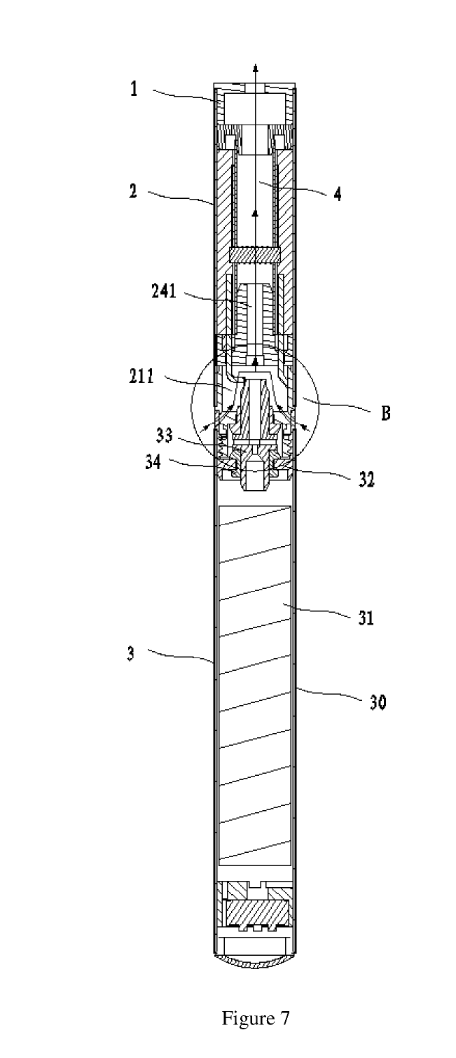

FIG. 7 shows an electronic cigarette provided in a second preferred embodiment of the present invention, which differs from that of the first preferred embodiment in a structure of the first air intake hole 321.

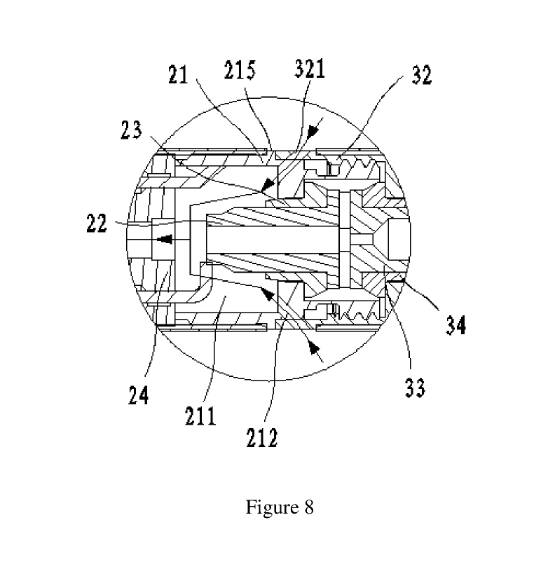

As shown in FIG. 8, at least one first air inlet hole 321 is defined on a peripheral wall of one end of the first connection sleeve 32 which is close to the atomization assembly 2, and the first air inlet hole 321 is communicated with the second air inlet hole 212 to enable the airflow flows into the first accommodation chamber 211 sequentially through the first air inlet hole 321 and the second air inlet port 212. In the present embodiment, an axis of the first air inlet hole 321 coincides with an axis of the second air inlet hole 212.

Since the axis of the first air inlet hole 321 coincides with the axis of the second air intake hole 212, then the airflow is smoother, a generation of noise is reduced, smoking of the user is made easier, and an user satisfaction can be significantly improved.

In general, an electronic cigarette of the embodiments of the present invention has the following advantageous effects:

(1) The second inlet hole is an inclined structure, since one end of the second air inlet hole is formed on the inner wall of the first accommodation chamber, and the other end of the second air inlet hole extends toward a side close to the battery assembly, so that the airflow can flow toward the side of the atomization base and flow through the vent hole on the atomization base to enter into the smoking end and smoked by the users, it can prevent the airflow from directly impinging on the electrodes to effectively reduce the noise.

(2) Since the second air inlet hole is formed in the side wall of the first accommodation chamber, namely, the airflow enters the first accommodation chamber of the second connection sleeve through the air inlet hole and flows into the atomization assembly directly through the vent hole on the atomization base, so that the airflow can enter the smoking end without passing through electrodes within the electronic cigarette, then enabling a reduction of airflow passage bending, reducing a flow distance of the airflow, while reducing a number of air impinging on the electrodes, enabling the airflow to flow better and smooth, reducing a generation of the noise, so that the users smoke more easily.

(3) Since only when the first air inlet hole on the first connection sleeve is communicated with the second air inlet hole on the second connection sleeve, can the airflow flow from the outside into the electronic cigarette, so that the battery assembly can be used to match with and identify the atomization assembly to effectively prevent the electronic cigarette battery assembly from a combining use with a non-matching atomization assembly to avoid the malfunction, the abnormal taste and other issues when consumers use a combining used and non-matching electronic cigarette, thus quality of the electronic cigarette is more secure and reliable.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. An electronic cigarette comprising an electronic cigarette body, the electronic cigarette body is provided with a smoking end (1), an atomization assembly (2) for atomizing smoke oil, and a battery assembly (3) electrically connected to the atomization assembly (2) for supplying electrical power to the atomization assembly (2); wherein an airflow passage (4) communicating with the smoking end (1) for airflow to flow is defined in the electronic cigarette body; one end of the battery assembly (3) is provided with a first connection sleeve (32) connected to the atomization assembly (2), at least one first air inlet hole (321) is defined on a peripheral wall of the first connection sleeve (32); the atomization assembly (2) comprises an atomization base (24) for fixing components within the atomization assembly (2), and a second connection sleeve (21) insertably connected to the first connection sleeve (32); and
wherein the airflow passage (4) comprises a vent hole (241) and a first accommodation chamber (211), the vent hole (241) axially goes through the atomization base (24), the first accommodation chamber (211) is communicated with the vent hole (241) and is defined at an end of the second connection sleeve (21) , the end of the second connection sleeve (21) is opposite to the battery assembly (3); a side wall of the first accommodation chamber (211) is provided with at least one second air inlet hole (212) communicating the first accommodation chamber (211) and the first air inlet hole (321), an end of the second air inlet hole (212), opposite to the first accommodation chamber (211), extends toward a direction close to the battery assembly (3) and ensures that an angle formed by an extending direction of the second air inlet hole (212) and an axis of the second connection sleeve (21) is less than 90, so that an outside airflow is directly introduced into the first accommodation chamber (211) and then flows to the smoking end (1) through the vent hole (241).

2. The electronic cigarette according to claim 1, wherein an axis of the first air inlet hole (321) is perpendicular to an axis of the first connection sleeve (32) or coincides with an axis of the second air inlet hole (212).

3. The electronic cigarette according to claim 1, wherein the first connection sleeve (32) is in engagement with the second connection sleeve (21), the first air inlet hole (321) is provided on the peripheral wall of the first connection sleeve (32), the peripheral wall of the first connection sleeve (32) is close to the atomization assembly (2).

4. The electronic cigarette according to claim 3, wherein quantity of the first air inlet hole (321) is plural, a plurality of first air inlet holes (321) are uniformly distributed on the peripheral wall of the first connection sleeve (32) surrounding an axis of the first connection sleeve (32).

5. The electronic cigarette according to claim 1, wherein the second connection sleeve (21) is convexly provided with an annular outer flange (215), the second air inlet hole (212) is provided on a side of the annular outer flange (215), the side of the annular outer flange (215) is close to the battery assembly (3).

6. The electronic cigarette according to claim 1, wherein the battery assembly (3) further comprises a battery sleeve (30), and a battery (31) fixed in the battery sleeve (30) and configured for supplying the electrical power to the atomization assembly (2), the first connection sleeve (32) is fixed at an end of the battery sleeve (30), the end of the battery sleeve (30) is close to the atomization assembly (2), and the first connection sleeve (32) is electrically connected to the battery (31) and the second connection sleeve (21), respectively.

7. The electronic cigarette according to claim 6, wherein an inner peripheral surface of the first connection sleeve (32) is provided with internal screw threads, a first annular flange (322) is convexly formed on an inner wall of the first connection sleeve (32), a first insulating member (34) and a third connection member (33) are embedded successively in the first annular flange (322), the third connection member (33) is electrically connected to the battery (31).

8. The electronic cigarette according to claim 7, wherein the atomization assembly (2) further comprises an atomization sleeve (20), the atomization base (24) is fixed in the atomization sleeve (20), the second connection sleeve (21) is connected to an end of the atomization sleeve (20), the end of the atomization sleeve (20) is close to the battery assembly (3), and the second connection sleeve (21) is electrically connected to the first connection sleeve (32); a peripheral surface of the second connection sleeve (21) is provided with external screw threads matched with the inner screw threads.

9. The electronic cigarette according to claim 8, wherein an inner wall of the second connection sleeve (21) is convexly provided with a second annular flange (213), a second insulating member (23) and a fourth connection member (22) are embedded successively in the second annular flange (213), the fourth connection member (22) is electrically connected to the third connection member (34).

10. The electronic cigarette according to claim 9, wherein the atomization assembly (2) further comprises a heating wire assembly (26) for atomizing the smoke oil, and a vent tube (25) for fixing the heating wire assembly (26), the vent tube (25) is fixed on the atomization base (24).

11. The electronic cigarette according to claim 10, wherein the battery assembly (3) further comprises an airflow sensor configured for detecting an airflow signal, and a control unit for receiving a signal generated by the airflow sensor and controlling an operating state of the heating wire assembly (26) in response to the signal, the control unit is respectively connected to the battery (31) and the airflow sensor.

12. The electronic cigarette according to claim 1, wherein the smoking end (1) is detachably connected to the atomization assembly (2).
